(19) United States
(12) Patent Application Publication
(10) Pub. No.: US 2017/0066925 A1
(43) Pub. Date: Mar. 9, 2017

(54) INKJET-PRINTABLE FOIL BALLOON AND IT'S FABRICATION

(71) Applicant: BROTHER INTERNATIONAL CORPORATION, Bridgewater, NJ (US)

(72) Inventor: Kangning LIANG, Bartlett, TN (US)

(73) Assignee: BROTHER INTERNATIONAL CORPORATION, Bridgewater, NJ (US)

(21) Appl. No.: 14/844,150

(22) Filed: Sep. 3, 2015

(51) Int. Cl. C09D 5/00; B29C 65/48; B41J 2/01

(52) U.S. Cl. CPC C09D 5/002; B41J 2/01; B29C 65/48; B29L 2022/022

(57) ABSTRACT

An inkjet printer-ready foil balloon comprises an ink-absorbing material and a special assembling form for the balloon, which allows an end user to personalize and print to the balloon on a conventional inkjet printer. The ink-absorbing material enables the balloon surface to become receptive to inkjet inks while a technique of manufacturing ensures that the balloon fits the form factor of a conventional inkjet printer.

### BACKGROUND

Metallic foil balloons are popular as toys and festive decorations. These balloons may be made, for example, of BoPET (biaxially-oriented polyethylene terephthalate), which is a polyester film made from stretched polyethylene terephthalate (PET). BoPET is widely available under a number of brand names, such as, e.g., Mylar®. For use in balloons, a BoPET film may have deposited upon it a layer of metal (e.g., aluminum), or one or more sheets of BoPET film may be laminated with other materials, such as, e.g., a thin layer of aluminum. (A balloon made of such materials may be referred to herein as a “foil balloon”.)

But personalization of a metallic foil balloon by a consumer is typically possible, if at all, only in limited ways. One constraint is that, of the two common types of printing devices—inkjet and laser printers—only inkjet is suitable for printing on heat-sensitive materials such as foil balloons. But it is practically impossible using a conventional home or office inkjet printer to directly print on a balloon a personalized design for a specific event, such as a birthday party or other celebration. The main reasons for this difficulty are that the balloon is made of materials that repel water (and therefore the water-based inks), and inkjet printers typically cannot accommodate objects that have the size and shape of a balloon.

One solution to this problem is to print images or designs onto adhesive labels, which are applied to the balloons. Labels for this purpose are well known and commercially available. But a balloon personalized with one of these labels may not look as good as one that has had an image deposited directly on its surface.

### BRIEF SUMMARY

Embodiments of the invention include materials that absorb and retain inks and that can be applied to commercial foil balloons. Applying such a material to the surface of a foil balloon enables forming an image on the surface of the balloon. Further, a foil balloon can be packaged to allow the balloon to be fed through a typical inkjet printer to apply the image to the balloon.

According to an embodiment of the invention, a formulation is provided that makes a metallized polyester film receptive to water-soluble inks. The formulation comprises a solvent, an ink-absorbing component, and a film-forming component.

In embodiments of the invention, the formulation comprises poly(vinyl pyrrolidone) (PVP). In an embodiment of the invention, the formulation comprises a polyurethane latex (PU), and the solvent is water. Further, in an embodiment of the invention, the formulation is PU-PVP.

Alternatively, in an embodiment of the invention, the formulation comprises poly(butyl methacrylate) (PBMA), and the solvent is an organic solvent. Further, in an embodiment of the invention, the formulation is PBMA-PVP.

According to an embodiment of the invention, a printable assembly comprises a backing sheet and a foil balloon that has two sides. A first side of the balloon is removably affixed to the backing sheet, and a second side of the balloon bears an ink-absorbing coating. In an embodiment of the invention, the foil balloon is affixed to the backing sheet such that the dimensions of the assembly substantially conform to the dimensions of the backing sheet.

In an embodiment of the invention, the ink-absorbing coating comprises PVP. Further, in an embodiment of the invention, the ink-absorbing coating comprises a polyurethane latex. Alternatively, in an embodiment of the invention, the ink-absorbing coating comprises PBMA.

In an embodiment of the invention, a method of creating a printable assembly that comprises a foil balloon comprises applying an adhesive to a first side of the balloon, removably affixing a backing sheet to the first side of the balloon, and applying to a second side of the balloon a formulation that comprises an ink-absorbing material. In an embodiment, a dimension of the balloon exceeds a corresponding dimension of the backing sheet, and the method comprises folding one or more portions of the balloon over one or more edges of the backing sheet, such that the dimensions of the assembly substantially conform to the dimensions of the backing sheet.

According to embodiments of the invention, the formulation comprises PVP. In an embodiment, the formulation also comprises a polyurethane latex. Alternatively, in an embodiment, the formulation also comprises PBMA.

In an embodiment of the invention, a method of applying an image to a surface of a foil balloon comprises applying an adhesive to a first side of the balloon, removably affixing a backing sheet to the first side of the balloon to form a printable assembly, applying to a second side of the balloon a formulation that comprises an ink-absorbing material, and feeding the printable assembly through an inkjet printer, the inkjet printer applying the image to the second side of the balloon. In an embodiment, a dimension of the balloon exceeds a corresponding dimension of the backing sheet, and the method comprises folding one or more portions of the balloon over one or more edges of the backing sheet, such that the dimensions of the printable assembly substantially conform to the dimensions of the backing sheet.

According to embodiments of the invention, the formulation comprises PVP. In an embodiment, the formulation also comprises a polyurethane latex. Alternatively, in an embodiment, the formulation also comprises PBMA.

### BRIEF DESCRIPTION OF THE DRAWINGS

The invention is illustrated in the figures of the accompanying drawings, which are meant to be exemplary and not limiting, and in which like references are intended to refer to like or corresponding things.

FIG. 1 depicts a foil balloon and a backing sheet aligned for creation of a printable assembly according to an embodiment of the invention.

FIG. 2 depicts parts of a foil balloon being folded over the edges of a backing sheet according to an embodiment of the invention.

### DETAILED DESCRIPTION OF THE PREFERRED EMBODIMENTS

Embodiments of the invention relate to making a foil balloon receptive to inks. First, according to embodiments of the invention, a balloon may be manufactured from foils that already have been coated with an ink-absorbing material. Second, according to embodiments of the invention, a balloon may be coated with an ink-absorbing material, possibly by an end user, after manufacture but before printing.

It will be appreciated that, in connection with embodiments of the invention, the suitability of an ink-absorbing material may depend on how well the formulation adheres to the surface of foil balloons as well as how well it absorbs and retains inks. Water-based formulations and organic-solvent-based formulations have both been found to be acceptable. But a formulation that is based on an organic solvent may be relatively more convenient to spray onto the surface and may also dry more quickly.

For example, in an embodiment of the invention, a formulation may be based on a volatile solvent for fast drying. The formulation may comprise an ink-absorbing component, e.g., poly(vinyl pyrrolidone) (PVP), and a film-forming and compatibility-enhancing component, e.g., poly(butyl methacrylate) (PBMA). Such a formulation may include additional components, such as a surfactant (e.g., Triton™ X-100) and plasticizer (e.g., dioctyl terephthalate (DOTP)).

An example of a suitable formulation (PBMA-PVP) is a mixture of 13.0 g of 6.5% PVP in isopropanol, 4.8 g of 20% PBMA in 2-butanone (MEK), and 20.9 g of acetone. The concentrations may vary in embodiments of the invention, representing a balance between efficiently delivering amounts of the components to the surface while keeping the solution from becoming so viscous as to inhibit spraying the solution onto a surface. According to embodiments of the invention, the weight ratio between PVP and PBMA can vary from 50 to 0.1, and is preferably 2 to 0.5.

This formulation can be sprayed onto a surface using a consumer hand sprayer. The thickness of the resulting coating may range from 10 microns to 500 microns and is preferably between 30 to 100 microns. It will be appreciated that this range of thicknesses may represent a balance between making the layer thick enough to absorb an aesthetically acceptable amount of inks while making it not so thick that it may distort the surface of the balloon or tend to peel off of that surface.

Alternatively, according to an embodiment of the invention, a water-based formulation may also be a suitable ink-absorbing material for foil balloons. One formulation (PU-PVP), for example, consists of a polyurethane latex (e.g., Dispercoll® U VPKA 8758, from Bayer Material Science), PVP, and Triton™ X-100. An example of a suitable mixture consists of 5.0 g of 20% PVP solution, 20.0 g of Dispercoll® U VPKA 8758, and 0.11 g of 10% Triton™ X-100. According to embodiments of the invention, The range of weight ratio between 20% PVP and Dispercoll® U VPKA 8758 can vary from 0.01 to 10, and is preferably between 0.1 and 0.5.

An ink-absorbing layer of PU-PVP can be formed, e.g., by rod-coating the formulation on the surface of a foil balloon, although other coating methods can also be used. The thickness of a coating of this formulation, applied in this way, may range from 10 microns to 500 microns and is preferably between 30 to 200 microns.

According to embodiments of the invention, foils for balloons can be coated on one surface (side) with an ink-absorbing material (e.g., PBMA-PVP or PU-PVP, as described above) before the foils are made into balloons. The coated sides become the exterior of a balloon after two sheets of these foils are bonded together to form a balloon, e.g., by an adhesive or a hot press procedure. Depending on the embodiment of the invention, either or both sides of the balloon can be printed on with an inkjet printer.

Alternatively, conventional foil balloons may be made printable after manufacture, according to embodiments of the invention, by applying an ink-absorbing material to them. The material can be applied by various methods, which may include, e.g., rod-coating, cast coating, doctor blade coating, spray coating or other coating methods. It will be appreciated that different coating methods may be more or less suitable for different formulations, and it will further be appreciated that some of these methods will be convenient for an end-user while others may be more appropriate for commercial applications.

For a balloon with a dark background color or a pre-printed image, a white coat or a primer coat may be needed before an ink absorbing layer is applied to it.

Although a foil balloon that has been made or treated as described above may be capable of receiving and retaining inkjet inks, it will be appreciated that conventional printers may not easily accommodate the various sizes and shapes of foil balloons. Therefore, according to an embodiment of the invention, a foil balloon may be placed in an assembly to make it compatible with the paper-taking mechanism of a printer in terms of size, shape, thickness, and physical strength., and shape. A suitable assembly will be seen not to cause media jam or touch the printer head during the printing process.

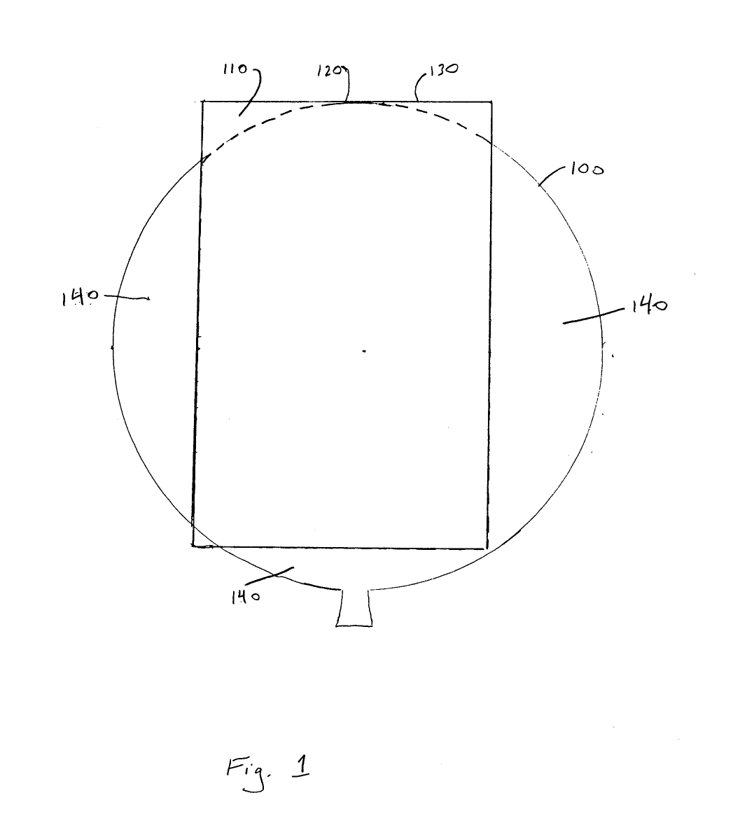

An assembly according to an exemplary embodiment of the invention may comprise a foil balloon that has roughly the shape of a circle with a diameter of about 19″. These dimensions are not critical, and suitable balloons are widely available. FIG. 1 depicts such a balloon 100 underneath a backing sheet 110 according to an embodiment of the invention.

In this assembly, the balloon 100 may be wrapped around, e.g., a backing sheet 110 such as a piece of 11″'17″ (or alternatively, for outside of North America, ISO B4) paper with the top 120 of the balloon 100 in line with the edge 130 of the paper 110 and with the median of the balloon 100 roughly superposing that of the paper 110. The sides 140 of the balloon 100 that extend beyond the edges of the corresponding sides of the paper 110 are wrapped around the edges to the other surface of the paper for temporary attachment. The balloon 100 can be secured to the paper 110 by applying a temporary adhesive to the side that is to be in contact with the paper 110.

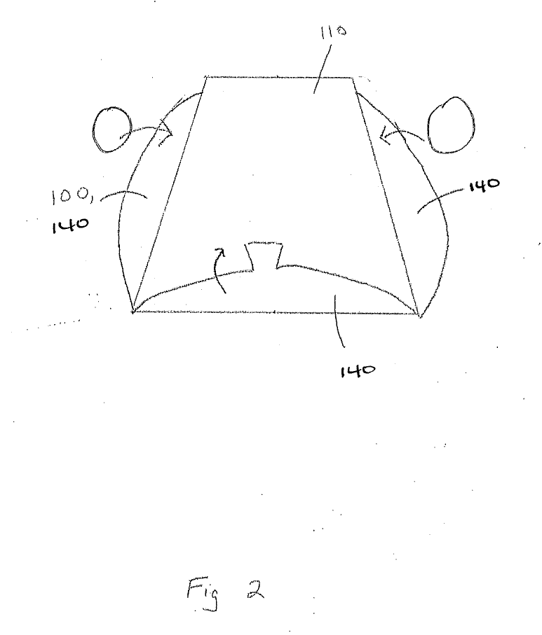

FIG. 2 depicts folding the sides 140 of the balloon 100 that extend beyond the edges of the paper 110 being wrapped around those edges to the other side of the paper 110 according to an embodiment of the invention.

Creation of a printable assembly, according to embodiments of the invention, may be illustrated through an exemplary manual process. For example, one side of circular foil balloon may be sprayed with a light coat of adhesive to make it slightly tacky. (In an exemplary embodiment of the invention, Blair® Maximum Strength Spray Adhesive is used, but it will be appreciated that many commercially available products are equally suitable.)

The balloon is then attached to a backing sheet, e.g., a sheet of paper. For a 19″ balloon, for example, suitable paper sizes may include either 11″×17″ or B4. The balloon may be attached to the sheet such that the top edge or point of the balloon is in line with the edge of the narrower side of the paper, and the balloon's median roughly overlaps that of the paper. The portions of the balloon that extend beyond the paper are folded over the edges and adhere temporarily to the other side of the paper.

It will be appreciated that the dimensions of an assembly prepared as above may be substantially the same as those of the backing sheet. Although the balloon may marginally add, e.g., width and thickness to the backing sheet, the assembly may still be fed through a conventional inkjet printer that has been configured to print on a sheet of paper having the dimensions of the backing sheet.

Once the balloon has been attached to the paper backing, in this example, the front surface of the balloon may sprayed with PBMA-PVP. If desired, a mask can ensure that the ink-absorbing material covers only certain areas of the balloon. The use of a volatile solvent in PBMA-PVP means that the coating of ink-absorbing material may dry sufficiently for further handling after only 10-15 minutes.

Once the ink-accepting surface has dried, it may be printed on, e.g., by a conventional inkjet printer such as, e.g., a Brother® MFC-J6710DW inkjet printer. For a printer that handles paper similarly to that model, the assembled sheet may be fed into the printer with its front side facing upward to print an image onto the balloon surface.

Once the balloon has been printed on, it may be detached from the paper backing and filled, e.g., with helium or air, in conventional ways.

This description of a manual process is merely illustrative and not limiting. It will be appreciated that some or all parts of creating a printable balloon or printable assembly according to embodiments of the invention may be automated. It will further be appreciated that some of the steps may be reordered according to embodiments of the invention: for example, a foil balloon may be attached to a backing sheet after application of an ink-absorbing material rather than before, or the spray adhesive may be sprayed to the backing sheet instead of the first side of the balloon, and then the foil balloon may be attached to the backing sheet.

It will further be appreciated that the reference to a 19″ circular balloon is also merely illustrative, and that balloons of other shapes and sizes may be used according to embodiments of the invention. Other sizes of backing sheets may be appropriate (for example, letter or A4 size), depending, e.g., on the size and shape of the balloon, the image on the balloon, and the specifics of the printer.

The claimed invention has been illustrated herein with reference to certain embodiments. Those embodiments are merely examples, however, and they merely illustrate the invention without limiting it. It will be appreciated that the principles underlying these examples apply generally, and the invention is limited only by the claims.

I claim:

1. A formulation for making a metallized polyester film receptive to water-soluble inks, the formulation comprising:
a solvent;
an ink-absorbing component; and
a film-forming component.

2. The formulation of claim 1, comprising PVP.

3. The formulation of claim 2, comprising a polyurethane latex, wherein the solvent is water.

4. The formulation of claim 3, wherein the formulation is PU-PVP.

5. The formulation of claim 2, comprising PBMA, wherein the solvent is an organic solvent.

6. The formulation of claim 5, wherein the formulation is PBMA-PVP.

7. A printable assembly, comprising:
a backing sheet; and
a foil balloon having two sides, a first side of the balloon being removably affixed to the backing sheet, and a second side of the balloon bearing an ink-absorbing coating.

8. The assembly of claim 7, wherein the foil balloon is affixed to the backing sheet such that the dimensions of the assembly substantially conform to the dimensions of the backing sheet.

9. The assembly of claim 7, wherein the ink-absorbing coating comprises PVP.

10. The assembly of claim 9, wherein the ink-absorbing coating comprises a polyurethane latex.

11. The assembly of claim 9, wherein the ink-absorbing coating comprises PBMA.

12. A method of creating a printable assembly that comprises a foil balloon, the method comprising:
applying an adhesive to a first side of the balloon;
removably affixing a backing sheet to the first side of the balloon; and
applying to a second side of the balloon a formulation that comprises an ink-absorbing material.

13. The method of claim 12, wherein a dimension of the balloon exceeds a corresponding dimension of the backing sheet, the method comprising folding one or more portions of the balloon over one or more edges of the backing sheet, such that the dimensions of the assembly substantially conform to the dimensions of the backing sheet.

14. The method of claim 12, wherein the formulation comprises PVP.

15. The method of claim 14, wherein the formulation comprises a polyurethane latex.

16. The method of claim 14, wherein the formulation comprises PBMA.

17. A method of applying an image to a surface of a foil balloon, the method comprising:
applying an adhesive to a first side of the balloon;
removably affixing a backing sheet to the first side of the balloon to form a printable assembly;
applying to a second side of the balloon a formulation that comprises an ink-absorbing material; and
feeding the printable assembly through an inkjet printer, the inkjet printer applying the image to the second side of the balloon.

18. The method of claim 17, wherein a dimension of the balloon exceeds a corresponding dimension of the backing sheet, the method comprising folding one or more portions of the balloon over one or more edges of the backing sheet, such that the dimensions of the printable assembly substantially conform to the dimensions of the backing sheet.

19. The method of claim 17, wherein the formulation comprises PVP.

20. The method of claim 19, wherein the formulation comprises a polyurethane latex.

21. The method of claim 19, wherein the formulation comprises PBMA.
